(19) United States
(12) Patent Application Publication
(10) Pub. No.: US 2004/0261560 A1
(43) Pub. Date: Dec. 30, 2004

(54) Dual-detent derailleur shifting apparatus

(75) Inventor: Ming-Chih Tsai, LuJu City (TW)

Correspondence Address: BRUCE H. TROXELL, SUITE 1404, 5205 LEESBURG PIKE, FALLS CHURCH, VA, 22041, US

(73) Assignee: SunRace Sturmey-Archer Inc.

(21) Appl. No.: 10/851,110

(22) Filed: May 24, 2004

(30) Foreign Application Priority Data
Jun. 27, 2003 (TW) 092117514

(51) Int. Cl. G05G 5/08

(52) U.S. Cl. 74/473.25

(57) ABSTRACT

The present invention is a dual-detent shifting apparatus, comprising a supporting seat, an actuating piece, and a detent piece. The supporting seat has plural cable-winding positioning slots and plural cable-releasing positioning slots. The actuating piece is pivotally connected to the supporting seat and has a cable-winding detent suppressor and a cable-releasing detent suppressor. The cable-winding detent suppressor and the cable-releasing detent suppressor may be axially rotated with the actuating piece synchronically. The detent piece has a cable-winding detent and a cable-releasing detent. When the actuating piece is rotated from cable-winding position to cable-releasing position, the cable-winding detent suppressor may drive the cable-winding detent away from the cable-winding positioning slot and the cable-releasing detent suppressor may then drive the cable-releasing detent to be inset into cable-releasing positioning slot. When the actuating piece is reversed, the cable-releasing detent suppressor may drive the cable-releasing detent away from the cable-releasing positioning slot and the cable-winding detent suppressor drives the cable-winding detent to be inset into the cable-winding positioning slot. Since the shifting positioning slots are positioned by different detents so, not only the shifting motions are more smooth and without interference, but also the cable-winding positioning slot and the cable-releasing positioning slot may have different spacing distances, such that the derailleur may accurately be meshed with the shifting gearwheel to smoothly complete the shifting actions.

### 1. FIELD OF THE INVENTION

The present invention relates to a dual-detent shifting apparatus, and more particularly, to a shifting apparatus having dual positioning detents for controlling the cable-winding and cable-releasing respectively and without interfering with each other such that the shifting is more smooth, in addition, the spacing between notches for cable-winding may be arranged independent to those of cable-releasing, such that the guide pulley can engage with the sprocket accurately to complete the shifting.

### 2. BACKGROUND OF THE INVENTION

Following the technical development of bicycle manufacture, the users of multi-speed or variable-speed derailleur bicycle are also increased. For a common derailleur bicycle, a shifter is arranged at the handlebar of the bicycle and the shifter can be twisted to adjust the tensions of cable for engaging the derailleur to a corresponding sprocket, thereby to change the speed of the bicycle. There are many prior structures of the shifter. For example, “Derailleur Actuating Apparatus for Bicycle” (ROC Pat. No. 522,969) as shown in FIG. 1. The aforesaid derailleur actuating apparatus 10 comprises a body 11 and a spring 12. The body 11 has a plurality of positioning slots 111. When the body 11 is rotated, the end part 121 of the spring 12 may be inset into different positioning slot 111 so as to change the speed of the bicycle. However, the way that the spring 12 faces toward the positioning slot will enable the spring 12 to have a slanting directionality, so the positioning slot 111 and the end part 121 will in some way resist each other and an extremely large resistance will be generated when the body 11 is rotated clockwise for cable-releasing. Therefore, the rotation of the body 11 is not smooth. Not only the feel is stiff and uncomfortable, but also parts are worn out easily. Usually, the clockwise rotation of the body 11 is used for releasing a cable, such that it is easier to wind the cable than release the cable in a traditional derailleur shifter.

Other prior arts, such as: “Detent Spring for Rotatable Grip Actuating System” (U.S. Pat. No. 5,524,501) and “Detent Spring for Rotatable Grip Actuating System” (U.S. Pat. No. 5,662,000), had disclosed a derailleur actuating apparatus that when the body thereof is rotated in one direction, the aforementioned resistance will be generated between the spring and the body. Not only the feel is stiff and uncomfortable, but also the parts are worn out easily. Since their structures are similar to that of aforementioned prior art, so repetitious description is not presented herein.

Please refer to FIG. 2. In a traditional derailleur mechanism, the guide pulley 31 of a rear derailleur 30 is cooperated with a freewheel set 20, and the guide pulley 31 has meshed teeth 311 arranged and aligned on the circumference of the same for engaging with a chain (not shown). As seen, the rear derailleur 30 is connected to a cable 32, which passes through a shell 33 and further connects to the body 11 of the aforesaid derailleur actuating apparatus 10. The freewheel set 20 has freewheels 21˜28 of different diameters. The closer to the center of the bicycle, the larger the diameter of the freewheel is. When the body 11 is actuated such that the cable 32 is pull to bring along the guide pulley 31, the guide pulley 31 is moved to a designated freewheel 21˜28, and in consequence, the chain can engage to the corresponding freewheel sprocket so as to achieve the objective of speed shifting. Please refer to FIG. 2A, the three freewheels 21, 22, 23 are used as example. When the guide pulley 31 moves from the small freewheel 21 toward the large freewheel 23, it is the cable-winding state (i.e. decelerating). On the other hand, when the guide pulley 31 moves from large freewheel 23 toward small freewheel 21, it is the cable-releasing state (i.e. accelerating). In an ideal situation, the guide pulley 31 can be accurately moved to the position right below the corresponding freewheel so that a quick cable-winding or cable-releasing operation can be accomplished. However, in the real world, because of the friction generated inside the derailleur, in the shifter and between the cable 32 and the shell 33, the guide pulley 31 is not positioned accurately. As shown in FIG. 2, if the guide pulley 31a is located originally below the freewheel 21, when the guide pulley 31a is moved toward the freewheel 22 (i.e., the cable is being winded), the position of the guide pulley 31a will offset to the right (31a′). If the guide pulley 31b is located originally below the freewheel 23, when the guide pulley 31b is moved toward the freewheel 22 (i.e., the cable is being released), the position of the guide pulley 31b will offset to the left (31b′). For compensating the offset, common shifter or derailleur shall have a cable-adjusting device for adjusting the tension of the cable 32. However, if the positioning for cable-winding is accurately adjusted, then the positioning or cable-releasing 31b′ will be offset more to the left. In the same way, if the positioning for cable-releasing is accurately adjusted, then the positioning for cable-winding 31a′ will be offset more to the right. Hence, the shifting operation will be more difficult. The reason for aforesaid situation that the adjustments can not be accomplished simultaneously is that there is only one positioning spring arranged in the traditional derailleur shifting apparatus having stationary gap between the positioning slots, such that the cable-winding operation and the cable-releasing operation will interfere with each other and can not be adjusted independently. This shortcoming exists in each aforementioned prior art.

Please refer to FIG. 3, which is a drawing according to “Twist Shifter for Controlling the Derailleur of A Bicycle” (U.S. Pat. No. 6,021,688). Wherein, the derailleur actuating apparatus 40 has an actuator plate 43, and when the body 41 is rotated clockwise to release cable (i.e., cable-releasing), the actuator plate 43 will press down the spring 42 to separate the spring 42 from the positioning slot 411 to thereby improve the said rugged problem during cable-releasing rotation. However, when external force (hand) rotates the body 11 clockwise and the actuator plate 43 presses down the spring 42 to encounter the next positioning slot 412, the control of the rotation must be accurate for enabling the spring 42 to fit into the next positioning slot 412. In other words, once the hand rotates the body 41 too fast for the spring 42 to bounce back and fit into the positioning slot 412, the spring 42 will miss the intended shifting position and fit into the positioning slot 413 next to the intended positioning slot 412. This is not a result desired by a rider and is indeed a shortcoming of the prior structures. Furthermore, since there is only one spring 42 arranged in the prior structures, so the aforementioned offset problem still can not be solved.

### SUMMARY OF THE INVENTION

In view of the shortcomings of the prior arts, the primary object of the present invention is to provide a dual-detent shifting apparatus, wherein two positioning detents respectively control the cable-winding and cable-releasing actions, such that the two shifting actions don't interfere with each other and can be operated smoothly to effectively reduce the wear of parts and prolong the life span thereof.

Another object of the present invention is to provide a dual-detent shifting apparatus having independent cable-winding function and cable-releasing function, so that the spacing between the position slots needed for cable-winding and cable-releasing can be designed respectively and independently, and in consequence, the guide pulley can engage the freewheel sprocket accurately for accomplishing the shifting actions smoothly. Therefore, the shifting function is enhanced and also the matching between relative parts (such as: shifter, chainwheel, freewheel, etc.) is enhanced.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a sectional view of a derailleur shifting apparatus according to prior art.

FIG. 2 is a schematic diagram depicting a guide pulley cooperating with a freewheel set according to the prior arts.

FIG. 2A is a schematic diagram showing a shifting operation according to prior art.

FIG. 3 is another sectional view of a derailleur shifting apparatus according to prior art.

FIG. 4 is a 3-D explosive view depicting a preferred embodiment of the present invention.

FIG. 4A is a rear view of the supporting seat of the present invention.

FIG. 5 is a 3-D assembling diagram of the present invention.

FIG. 5A is an assembling sectional view depicting a preferred embodiment of the present invention.

FIG. 6A to FIG. 6C are illustrations of cable-winding actions according to the present invention.

FIG. 7A to FIG. 7C are illustrations of cable-releasing actions according to the present invention.

FIG. 8 to FIG. 11 are sectional views showing structures of different preferred embodiments according to the present invention.

FIG. 12 is a 3-D explosive view depicting yet another preferred embodiment with two independent detent pieces according to the present invention.

FIG. 13A and FIG. 13B are respectively the front and the rear view of the actuating part of FIG. 12.

FIG. 14 is an assembling sectional view of FIG. 12.

FIG. 15A to FIG. 15C are illustrations of cable-winding actions of FIG. 12.

FIG. 16A to FIG. 16C are illustrations of cable-releasing actions of FIG. 12.

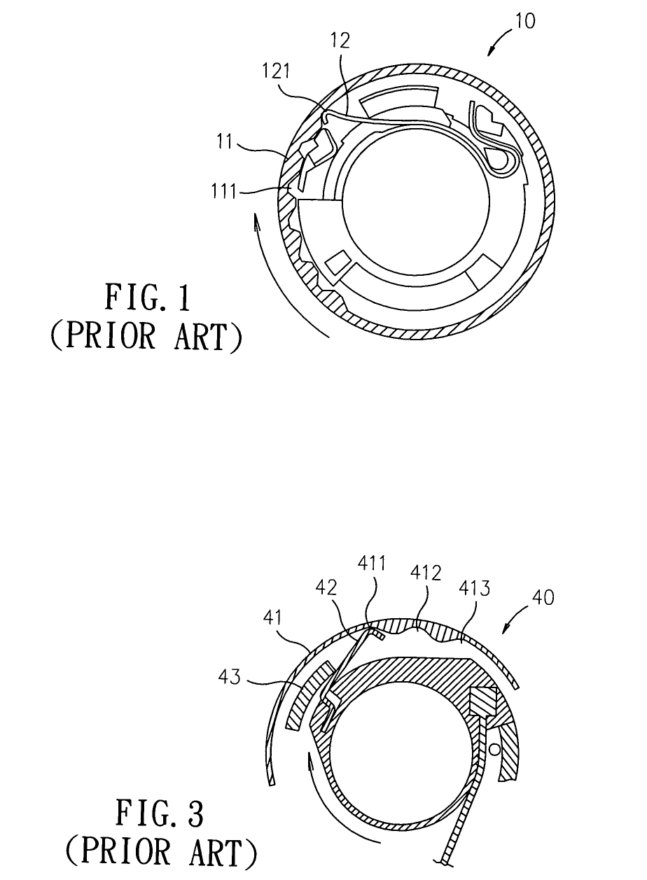

### DETAILED DESCRIPTION OF THE INVENTION

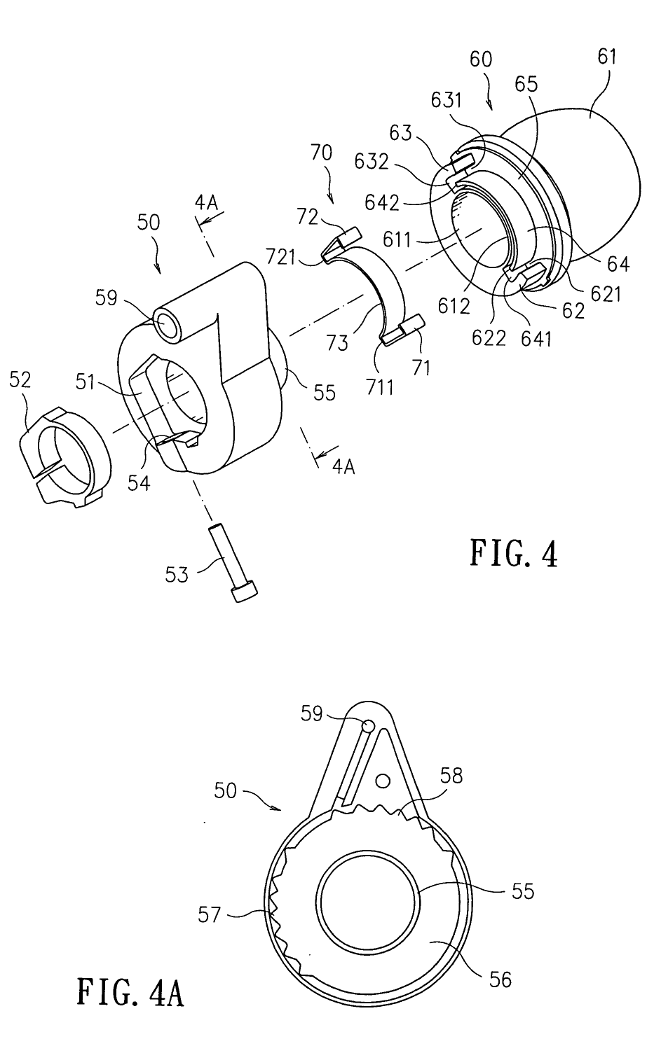

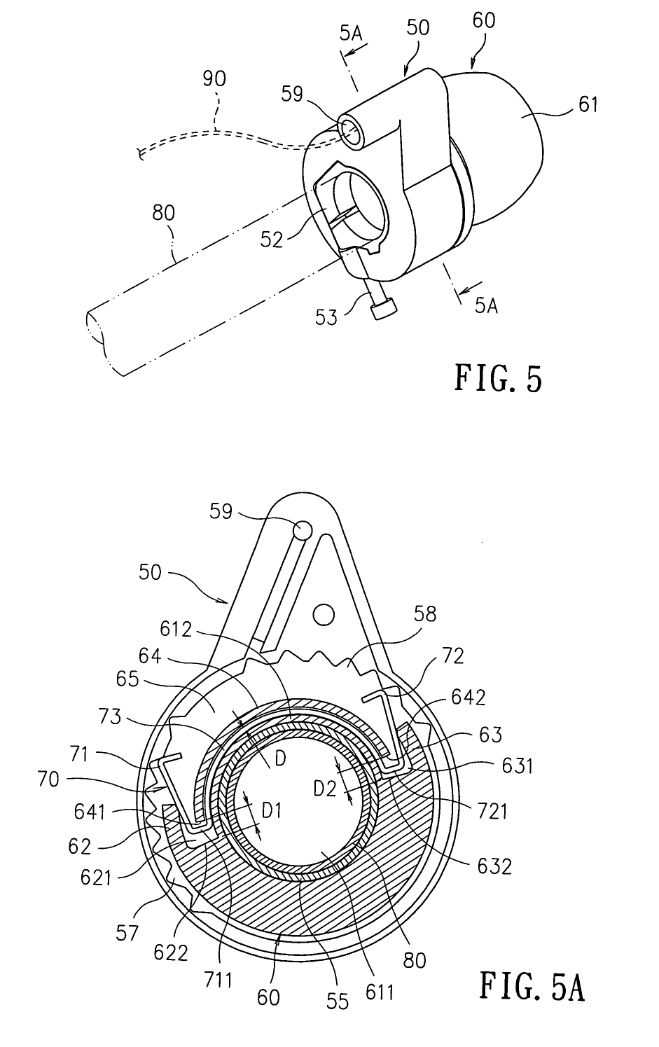

Please refer FIG. 4 to FIG. 5A, which show a dual-detent shifting apparatus of the present invention, mainly comprising a supporting seat 50, an actuating piece 60, and a detent piece 70.

As sown, the supporting seat 50 is cooperated with a C-shaped ring 52 of irregular contour, and a recess 51 corresponding to the contour of the C-shaped ring 52 is arranged at the axial center of the supporting seat 50 so that the C-shaped ring 52 can be inset in the recess 51, furthermore, a fixing bolt 53 is bolted into the borehole 54 of the supporting seat 50 from the exterior of the supporting seat 50 for pressing and fixing the C-shaped ring 52 to the handlebar 80 of the bicycle. Thereby, the supporting seat 50 is fixed securely to the body of the bicycle. Please refer to FIG. 4 and FIG. 4A, a sleeve 55 is arranged at a side of the supporting seat 50 opposite to the recess 51 which is coaxial to the supporting seat 50, and a recess 56 is arranged on the surface of the supporting seat 50 where the sleeve 55 is arranged, moreover, a plurality of cable-winding position slots 57 are continuously formed within a predefined angular range of the inner periphery of the recess 56 and a plurality of cable-releasing position slots 58 are also continuously formed within another predefined angular range of the inner periphery of the recess 56. The spacing between the cable-winding positioning slots 57 and the spacing between the cable-releasing positioning slots 58 are designed according to real needs and are unnecessarily to be the same. A via hole 59 is arranged at one side of the supporting seat 50 for the shifting cable 90 of the bicycle to pass through from outside the supporting seat 50 and further connect to an internal part of the actuating piece 60.

The actuating piece 60 connected to the shifting cable 90 has a gripping part 61 which has a penetrating part 611 arranged at the side facing the supporting seat 50 for accommodating the sleeve 55. The handlebar 80 of bicycle may also be arranged passing through the penetrating part 611. A recessing radial platform 65 is formed surrounding the circumference of the penetrating part 611 such that there is a wall 612 formed between the penetrating part 611 and the platform 65. A cable-winding detent suppressor 62 and a cable-releasing detent suppressor 63 are arranged on the platform 65 in a way that accommodating spaces 621, 631 are arranged respectively between the wall 612 and the cable-winding detent suppressor 62, and between the wall 612 and the cable-releasing detent suppressor 63. Pushing pieces 622, 632 respectively connected to the cable-winding detent suppressor 62 and the cable-releasing detent suppressor 63 are arranged in the accommodating spaces 621, 631. A flange 64 is arranged around the wall 612. The ends 641, 642 of the flange 64 are faced toward the accommodating spaces 621, 631 and respectively is at an appropriate distance D1, D2 away from the pushing pieces 622, 632. An accommodating space formed between the inside wall of the flange 64 and the wall 612 is available for the detent piece 70 to be inset therein.

The detent piece 70 is formed all-in-one using an elastic metal sheet having an cable-winding detent 71 and a cable-releasing detent 72. The cable-winding detent 71 is arranged in the accommodating space 621 that is formed between the cable-winding detent suppressor 62 and the penetrating part 611 of the actuating piece 60. The cable-releasing detent 72 is arranged in the accommodating space 631 that is formed between the cable-releasing detent suppressor 63 and the penetrating part 611 of the actuating piece 60. An arcuate connecting part 73 is arranged between the cable-winding detent 71 and the cable-releasing detent 72. The arcuate connecting part 73 is inset between the inside wall of the flange 64 of the said actuating piece 60 and the outside wall of the penetrating part 611. The cable-winding detent 71 may be extended out of the accommodating space 621 and be faced toward the cable-winding positioning slot 57. The cable-releasing detent 72 may be extended out of the accommodating space 631 and be faced toward the cable-releasing position slot 58. A connecting part 711 is arranged between and connects the cable-winding detent 71 and the arcuate connecting part 73. Another connecting part 721 is arranged between and connects the cable-releasing detent 72 and the arcuate connecting 73. The cable-winding detent 71, the connecting part 711, the arcuate connecting part 73, the connecting part 721, and the cable-releasing detent 72 are connected to form an unity having an average thickness D. The connecting part 711 is inset between the end of the flange 64 and the pushing piece 622. The thickness D of the connecting parts 711, 721 are all smaller than the distances D1, D2.

After said components are assembled, the wall 612, the flange 64, the arcuate connecting part 73, and the sleeve 55 share a same axial center. The supporting seat 50 is arranged securely at the body of the bicycle. The gripping part 61 may be rotated externally to make the cable-winding detent suppressor 62, the cable-releasing detent suppressor 63, the pushing pieces 622, 632, and the wall 612 inside the gripping part 61 to rotate synchronically. The rotating angle of the cable-winding detent suppressor 62 may cover the predefined range of the cable-winding positioning slot 57. The rotating angle of the cable-releasing detent suppressor 63 may cover the predefined range of the cable-releasing positioning slot 58. Since an designated distance D1, D2 is arranged between two end 641, 642 of the flange 64 and the pushing pieces 622, 632 and the thickness D of the connecting parts 711, 721 is smaller than the distances D1, D2, so a pushing action may be acted to the connecting parts 711, 721, when the pushing pieces 622, 632 are rotated. For example, when the actuating piece 60 is rotated in counterclockwise direction, the detent piece 70 will not follow the actuating piece 60 to rotate temporarily, because the cable-releasing detent 72 and the cable-releasing positioning slot 58 are still meshed together. The cable-releasing detent suppressor 63 may press down the cable-releasing detent 72 so as to separate the same from the cable-releasing positioning slot 58. In the meantime, the cable-winding detent suppressor 62 at another side may therefore release the cable-winding detent, such that the cable-winding detent 71 and the cable-winding positioning slot 57 are meshed together. Next, the pushing piece 632 also contacts the connecting part 721 and starts to push the detent piece 70. Vice versa, when the actuating piece 60 is rotated in clockwise direction, the detent piece 70 will not follow the actuating piece 60 to rotate temporarily, because the cable-winding detent 71 and the cable-winding positioning slot 57 are still meshed together. The cable-winding detent suppressor 62 may press down the cable-winding detent 71 so as to separate the same from the cable-winding positioning slot 57. In the meantime, at another side, the cable-releasing detent suppressor 63 may therefore release the cable-releasing detent 72, such that the cable-releasing detent 72 and the cable-releasing positioning slot 58 are meshed together. Next, the pushing piece 622 also contacts the connecting part 711 and starts to push the detent piece 70.

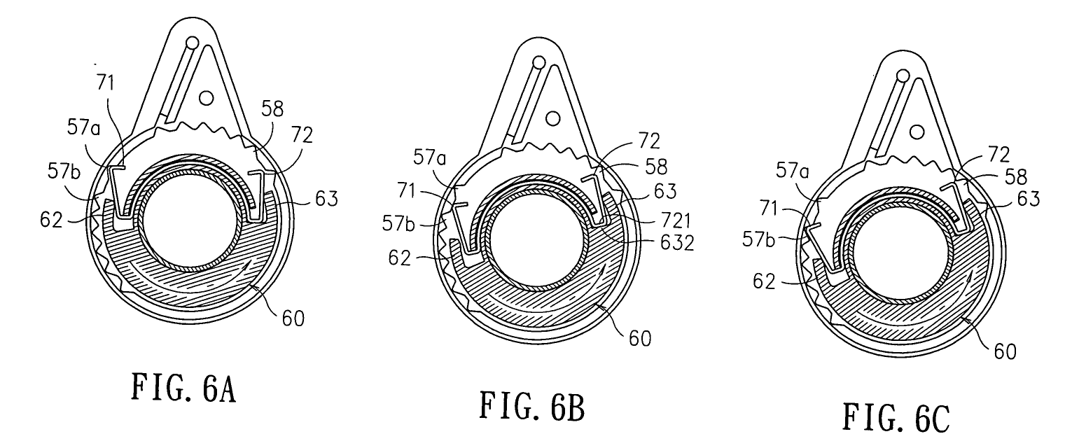

Please refer to FIG. 6A to FIG. 6C, which are illustrations of the continuous cable-winding action. In FIG. 6A, the cable-winding detent 71 is originally engaged with the cable-winding positioning slot 57a, and the cable-releasing detent 72 is separated from the cable-releasing positioning slot 58 since the cable-releasing detent 72 is being pressed down by the cable-releasing detent suppressor 63. In FIG. 6B, when the pushing piece 60 is rotated in counterclockwise direction, the cable-releasing detent suppressor 63 will press down the cable-releasing detent 72, and the pushing piece 632 will push the connecting part 72, such that the cable-winding detent 71 is being separated from the cable-winding positioning slot 57a and moves toward the next cable-winding positioning slot 57b. In FIG. 6C, when the cable-winding detent 71 engages with the cable-winding positioning slot 57b, a cable-winding action is completed, that is, it is shifted from a higher gear to a lower gear. From FIG. 6A to FIG. 6C, it is known that, when each cable-winding action is proceeded, the cable-releasing detent 72 is always being separated from the cable-releasing positioning slot 58, so a smooth cable-winding action is guaranteed.

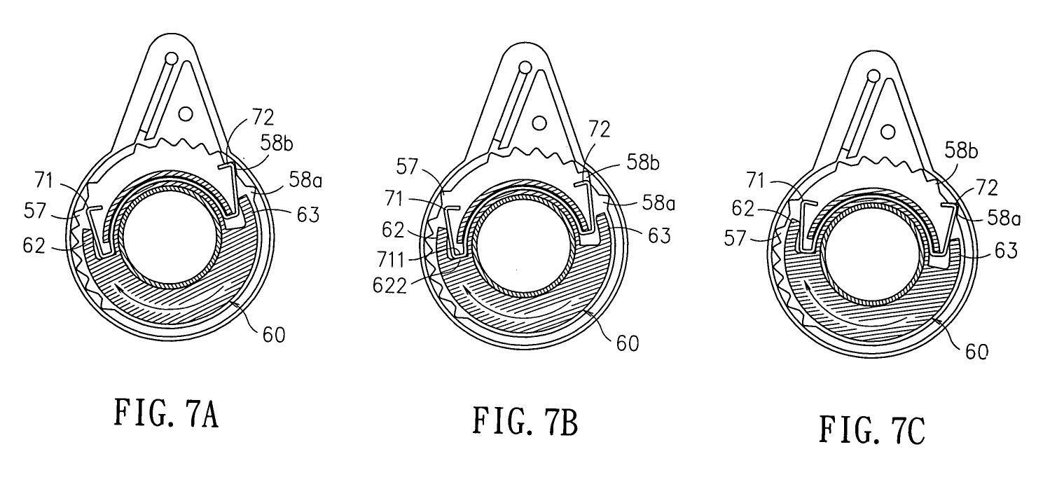

Please refer to FIG. 7A to FIG. 7C, which are illustrations of a continuous cable-releasing action. As shown in FIG. 7A, the cable-releasing detent 72 is originally engaged with the cable-releasing positioning slot 58b, and the cable-winding detent 71 is separated from the cable-winding positioning slot 57 since the cable-winding detent 71 is being pressed down by the cable-winding detent suppressor 62. As shown in FIG. 7B, when the pushing piece 60 is rotated in clockwise direction, the cable-winding detent suppressor 62 will press down the cable-winding detent 72, and the pushing piece 622 will push the connecting part 711, such that the cable-releasing detent 72 is being separated from the cable-releasing positioning slot 58b and moves toward the next cable-releasing positioning slot 58a. As shown in FIG. 7C, when the cable-releasing detent 72 engages with the cable-releasing positioning slot 58a, a cable-releasing action is completed, that is, it is shifted from a lower gear to a higher gear. From FIG. 7A to FIG. 7C, it is known that, when each cable-releasing action is proceeded, the cable-winding detent 71 is always separated from the cable-winding positioning slot 57, so a smooth cable-releasing action is guaranteed.

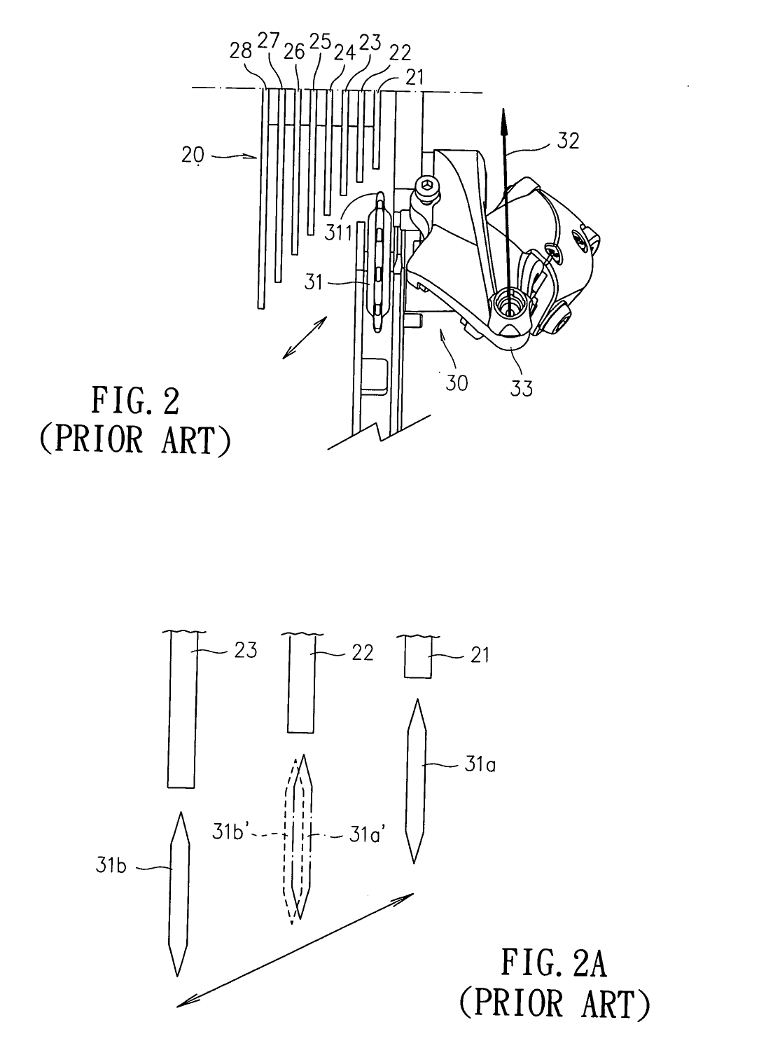

One thing must be pointed out that the cable-winding action and the cable-releasing action according to the present invention are independent to each other, so the smoothness of shifting action may be guaranteed, and the wear of parts may be reduced effectively to prolong their life span. Another characteristic of the present invention is that, since the cable-winding positioning slot 57 and the cable-releasing positioning slot 58 are arranged respectively and separately, so the spacing between of the cable-winding positioning slots 57 and the cable-releasing positioning slots 58 may be arranged according to the real situations. In other words, the spacing between of cable-winding position slots 57 may be the same or different, and the spacing between of cable-releasing position slots 58 may be the same or different, and the spacing between of cable-winding position slots 57 and cable-releasing position slots 58 may be the same or different. Thereby, the problem of inaccurate engaging between the guide pulley and the shifting freewheel as shown in FIG. 2A may be overcome, and the cable-winding action and the cable-releasing action may be operated smoothly. Furthermore, the shifting function is enhanced, and the matching of relative parts (e.g., shifter, flywheel, and gearwheel) may be enhanced.

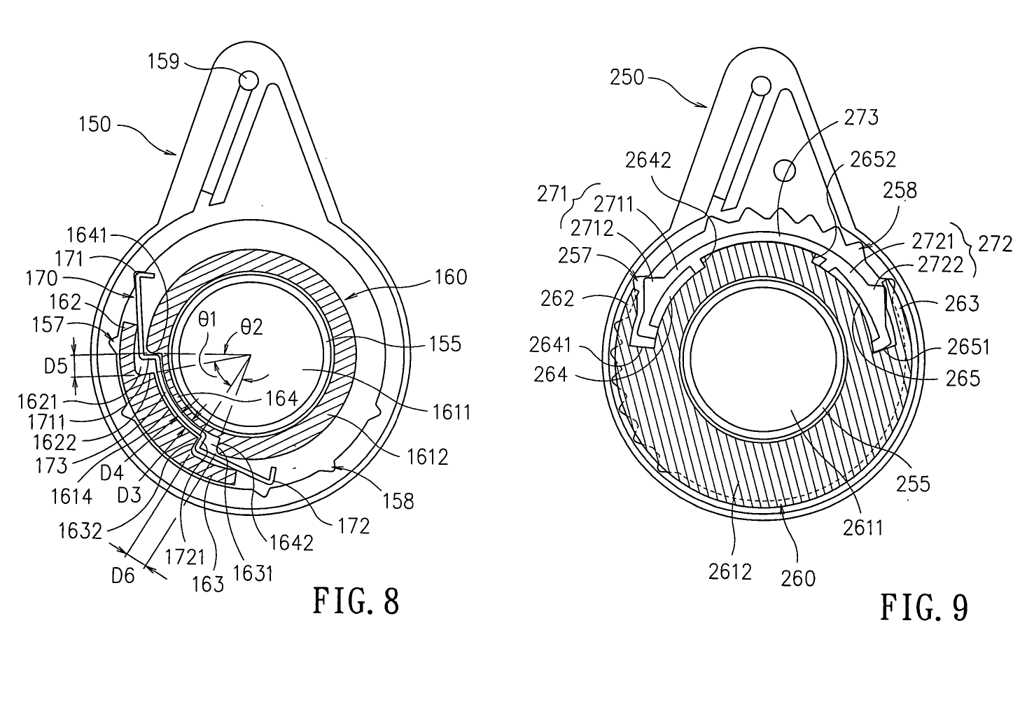

Please refer to FIG. 8, which shows another preferred embodiment of the present invention, mainly comprising a supporting seat 150, an actuating piece 160, and a detent piece 170.

The supporting seat 150 is arranged securely at the body of the bicycle. A sleeve 155 arranged coaxial to the supporting seat 150 that passes through and insets in the actuating piece 160 which shares the same axis with the sleeve 55, such that the actuating piece 160 and the supporting seat 150 are connected pivotally. A plurality of cable-winding position slots 157 and a plurality of cable-releasing position slots 158 are continuously formed within different predefined angular range of the inner periphery of the supporting seat 150. Compared with the embodiment shown in FIG. 5A, the spacing between the cable-winding slots 157 and the spacing between the cable-releasing slots 158 are larger, and both the number of the cable-winding slots 157 and the cable-releasing slots 158 are only three. That is, this embodiment may provide three speed levels. A via hole 159 is arranged at one side of the supporting seat 150 for the shifting cable of the bicycle (not shown in the figures) to pass through from outside the supporting seat 150 and further connect to an internal part of the actuating piece 60.

The actuating piece 160 has a penetrating part 1611 available for the sleeve 155 of the supporting seat 150 to be arranged therein. A wall 1612 is formed around the penetrating part 1611. A recess 164 is arranged at the outer rim of the wall 1612 and is formed as a fan shape of angle θ₂ extending in radial direction from the axial center of the actuating piece 160. A projecting part 1614 is arranged at a position corresponding to the recess 164 and is projected toward the recess 164. There is a distance D3 between the projecting part 1614 and the recess 164. The angle θ₁ of the extending fan of the projecting part 1614 is smaller than the angle θ₂ of the extending fan of the recess164 so, after the projecting part 1614 is inset into the recess 164, two sides of the projecting part 1614 form pushing pieces 1622, 1632. There is still a distance D5, D6 between the pushing pieces 1622, 1632 and two sides 1641, 1642 of the recess 164. Two sides of the projecting part 1614 are respectively arranged a cable-winding detent suppressor 162 and a cable-releasing detent suppressor 163 of slightly thinner thickness. Accommodating spaces 1621, 1631 are formed respectively among the projecting part 1614, the cable-winding detent suppressor 162, the cable-releasing detent suppressor 163 and between the recess 161, the wall 1612. Detent piece 170 is arranged between the projecting part 1614 and the recess 164 and among the pushing pieces 1622, 1632 and the wall 1612.

The detent piece 170 is formed all-in-one using an elastic metal sheet having an cable-winding detent 171 and a cable-releasing detent 172. The cable-winding detent 171 is arranged in the accommodating space 1621 that is formed between the cable-winding detent suppressor 162 and the wall 1612. The cable-releasing detent 172 is arranged in the accommodating space 1631 that is formed between the cable-releasing detent suppressor 163 and the wall 1612. An arcuate connecting part 173 is arranged between the cable-winding detent 171 and the cable-releasing detent 172. A connecting part 1711 is arranged between the cable-winding detent 171 and the arcuate connecting part 173. Another connection part 1721 is arranged between the cable-winding detent 172 and the arcuate connecting part 173. The cable-winding detent 171, the connecting part 1711, the arcuate connecting part 173, the connecting part 1721, and the cable-releasing detent 172 are connected to form an unity having an average thickness D4. The arcuate connecting part 173 is inset between the projecting part 1614 and the recess 1613. The connecting part 1721 is then inset between another side of the recess 164 and the pushing piece 1632. The cable-winding detent 171 may be extended out of the accommodating space 1621 and be faced toward the cable-winding positioning slot 157. The cable-releasing detent 172 may be extended out of the accommodating space 1631 and be faced toward the cable-releasing positioning slot 158. The thickness D4 of the connecting parts 1711, 1721 are all smaller than the distances D5, D6.

After aforementioned parts are assembled together and when the actuating piece 160 is rotated in counterclockwise direction, the cable-releasing detent suppressor 163 may press down the cable-releasing detent 172 to be separated from the cable-releasing positioning slot 158. The pushing piece 1632 may push the connecting part 1721 to move synchronically. In the meantime, the cable-winding detent suppressor 162 releases the cable-winding detent 171, such that the cable-winding detent 171 and the cable-winding positioning slot 157 are meshed together. Vice versa, when the actuating piece 160 is rotated in clockwise direction, the cable-winding detent suppressor 162 may press down the cable-winding detent 171 to be separated from the cable-winding positioning slot 157. The pushing piece 1622 may push the connecting part 1711 to be moved toward the side 1641 of the recess 164. In the meantime, the cable-releasing detent suppressor 163 releases the cable-releasing positioning slot 172, such that the cable-releasing detent 172 and the cable-releasing positioning slot 158 are meshed together.

Similarly, the cable-winding action and the cable-releasing action according to the present invention are independent to each other, so the smoothness of shifting action may be guaranteed, and the wear of parts may be reduced effectively to prolong their life span. Another characteristic of the present invention is that: since the cable-winding positioning slot 157 and the cable-releasing positioning slot 158 are arranged respectively, so the spacing between of the cable-winding positioning slots 157 and the cable-releasing positioning slots 158 may be arranged according to the real situations. In other words, those spacing between the cable-winding positioning slots 157 may be the same or different, those spacing between the cable-releasing positioning slots 158 may be the same or different, and the spacing between the cable-winding positioning slot 157 and the spacing between the cable-releasing positioning slot 158 may be the same or different. Thereby, the problem of inaccurate meshing between the guide pulley and the shifting freewheel as shown in FIG. 2A may be overcome completely, and the cable-winding action and the cable-releasing action may smoothly be operated. Furthermore, the shifting function is enhanced, and the matching of relative parts (e.g., shifter, flywheel, and gearwheel) may be enhanced.

Please refer to FIG. 9. The embodiment comprises a supporting seat 250, an actuating piece 260, a cable-winding detent 271, and a cable-releasing detent 272. The structure of the supporting seat 250 having cable-winding positioning slots 257 and cable-releasing positioning slots 258 is the same as that of the supporting seat 50 shown in FIG. 5A. Other structures are not repetitiously described herein in detail.

The actuating piece 260 has a penetrating part 2611 available for the sleeve 255 of the supporting seat 250 to be arranged therein. A wall 2612 is formed around the penetrating part 2611. Two recesses 264, 265 are respectively arranged at outside of the wall 2612 corresponding to the cable-winding positioning slot 257 and the cable-releasing positioning slot 258. A cable-winding detent suppressor 262 and a cable-releasing detent suppressor 263 are additionally and respectively arranged at outside of the recesses 264, 265. The cable-winding detent 271 is arranged in the recess 264, and the cable-releasing detent 272 is arranged at another recess 265.

The cable-winding detent 271 is all-in-one formed of an elastic material, and comprises a “ [symbol] ” shape elastic part 2711 and a projecting part 2712 arranged at outer rim of the elastic part 2711 capable of being inset with the cable-winding positioning slot 257. The cable-releasing detent 272 is also all-in-one formed of an elastic material, and comprises a “ [symbol] ” shape elastic part 2721 and a projecting part 2722 arranged at outside of the elastic part 2721 capable of being inset with the cable-releasing positioning slot 258. A connecting part 273 is arranged between the cable-winding detent 271 and the cable-releasing detent 272.

When the actuating piece 260 is rotated in counterclockwise direction, the cable-releasing detent suppressor 263 will press down the elastic part 2721 formed as “ [symbol] ” shape and the projecting part 2722 of the cable-releasing detent 272 to make the projecting part 2722 separated from the cable-releasing positioning slot 258. An inside wall 2651 of the recess 265 may push the cable-releasing detent 272 to move in counterclockwise direction synchronically. And, the inside wall 2642 of another recess 264 may then push the cable-winding detent 271 to move in counterclockwise direction synchronically, such that the cable-winding detent 271 is meshed to the cable-winding positioning slot 257. Vice versa, when the actuating piece 260 is rotated in clockwise direction, the cable-winding detent suppressor 262 will press down the elastic part 2711 formed as “ [symbol] ” shape and the projecting part 2712 of the cable-winding detent 271 to make the projecting part 2712 separated from the cable-winding positioning slot 257. An inside wall 2641 of the recess 264 may push the cable-winding detent 271 to move in clockwise direction synchronically. And, the inside wall 2652 of another recess 265 may then push the cable-releasing detent 272 to move in counterclockwise direction synchronically, such that the cable-releasing detent 272 is meshed to the cable-releasing positioning slot 258.

Similarly, the cable-winding action and the cable-releasing action according to the present invention are independent to each other, so the smoothness of shifting action may be guaranteed, and the wear of parts may be reduced effectively to prolong their life span. Another characteristic of the present invention is that: since the cable-winding positioning slot 257 and the cable-releasing positioning slot 258 are arranged respectively, so the spacing between the cable-winding positioning slots 257 and the spacing between the cable-releasing positioning slots 258 may be arranged according to real situations. In other words, those spacing between the cable-winding positioning slots 257 may be the same or different, those spacing between the cable-releasing positioning slots 258 may be the same or different, and the spacing between the cable-winding positioning slots 257 and the spacing between the cable-releasing positioning slots 258 may be the same or different. Thereby, the problem of inaccurate meshing between the guide pulley and the shifting freewheel as shown in FIG. 2A may be overcome completely, and the cable-winding action and the cable-releasing action may smoothly be operated. Furthermore, the shifting function is enhanced, and the compatibility of relative parts (e.g., shifter, flywheel, and gearwheel) may be enhanced.

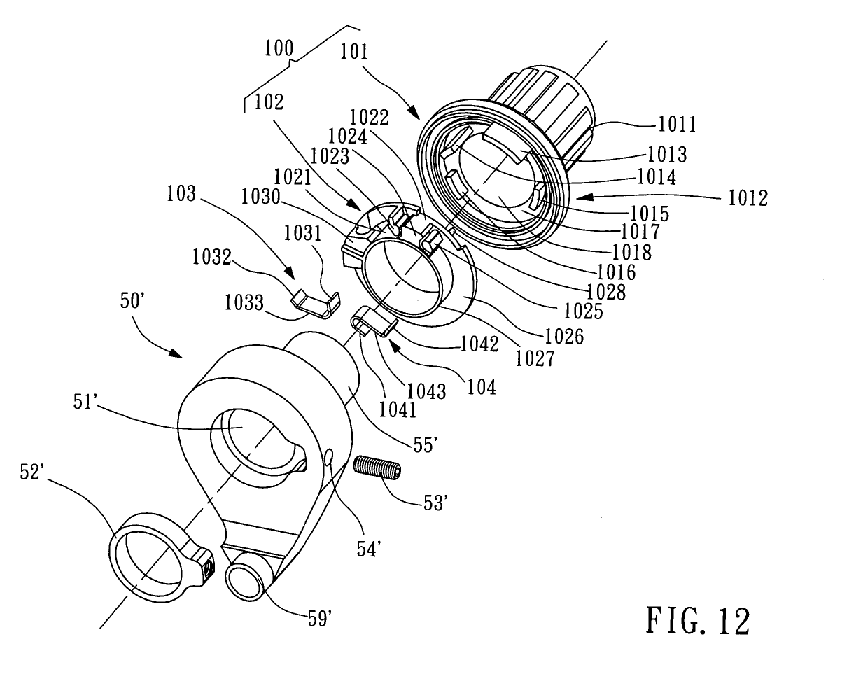

Please refer to FIG. 12, which shows another preferred embodiment of the present invention, mainly comprising: a supporting seat 50′, an actuating piece 100, a cable-winding detent piece 103 and a cable-releasing detent piece 104. The structure of the supporting seat 50′ having cable-releasing positioning slots 57′ and cable-positioning slots 58′ is the same as that of the supporting seat 50 shown in FIG. 5A. Other structures are not repetitiously described herein in detail.

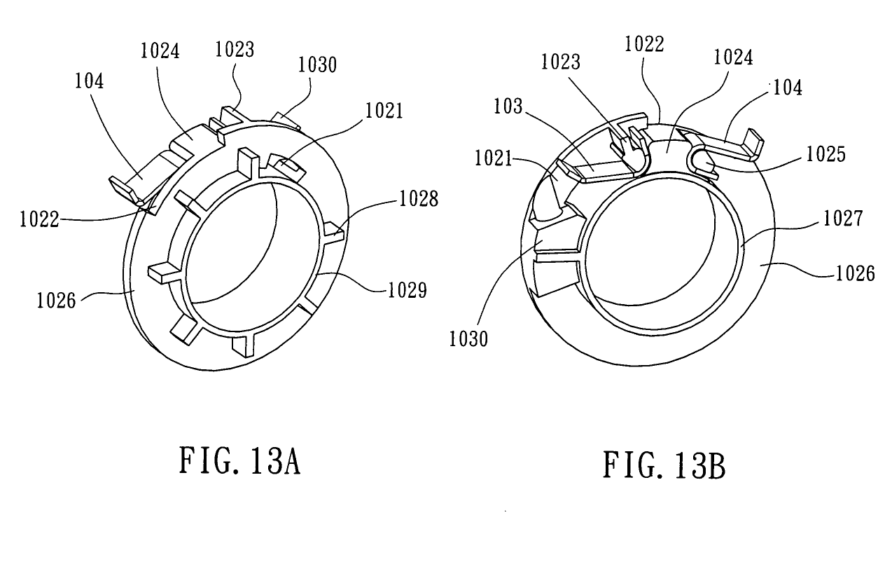

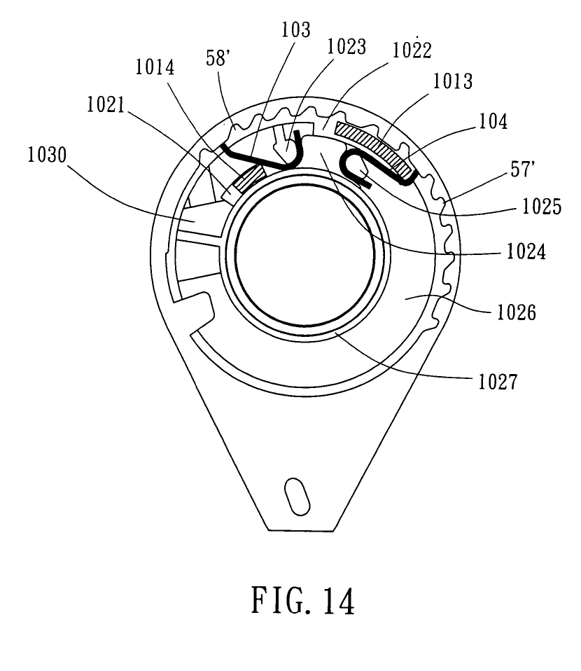

The actuating piece 100 comprises a gripping part 101 and an actuating part 102. The gripping part 101 further comprises a grip 1011, which is hollow and is capable of receiving the sleeve 55′ therein, and an enlarged portion 1012, connected to the gripping part 101, having an arc-shaped cable-releasing detent suppressor 1013, an arc-shaped cable-winding detent suppressor 1014, two arc-shaped positioning block 1015, 1016 being arranged on a circular plate 1017 thereof, and the circular plate 1017 being coaxially connected to the grip 1011. As seen in FIG. 13A and FIG. 13B with reference to FIG. 12, the actuating part 102 is a hollow circular plate 1026 with an arc-shaped indentation 1022 and a arc-shaped hole 1021 arranged respectively at the positions corresponding to the cable-releasing detent suppressor 1013 and the cable-winding detent suppressor 1014, wherein the indentation 1022 is used for accommodating the cable-releasing detent suppressor 1013, and the hole 1021 is used for accommodating the cable-winding detent suppressor 1014, and the arc widths of both the hole 1021 and the indentation 1022 are larger than those of the two suppressors 1013, 1014, In addition, a side of the circular plate 1026 facing toward the grip part 101 is formed thereon with a plurality of ribs 1028 distributed radially connected to a wall 1029 and corresponding to the two positioning block 1015, 1016, wherein the two block 1015, 1016 respectively insets into the spacing defined by any of the two neighboring ribs 1028 and the spacing will be large enough for allowing either of the block 1015, 1016 to move circularly therein and the difference of arc width between the spacing and the block disposed therein is larger than that between the indentation 1022 and the suppressor 1014 and also is larger that that between the hole 1021 and the suppressor 1013. Another side of the circular plate 1026 facing toward the supporting seat 50′ is formed thereon with two columns 1023, 1025, a wall 1027, a clamping block 1024 and a enforce block 1030, wherein the column 1023 is disposed at a specific arc distance to the right of the hole 1021 without contacting the wall 1027, and the clamping block 1024 is disposed slightly to the right of the column 1023 and the size and shape of the gap formed between the clamping block 1024 and the column 1023 is capable of clamping and fastening an end of a cable-winding detent 103, and the column 1025 is being disposed between the wall 1027 and the indentation 1022 and similarly slightly to the right of the clamping block 1024 to be disposed at an appropriate position corresponding to the indentation 1022 such that the size and shape of the gap formed between the clamping block 1024 and the column 1025 is capable of clamping and fastening an end of a cable-releasing detent 104, and the enforce block 1030 is disposed adjacent to the left end of the hole 1021.

The cable-winding detent piece 103 is formed all-in-one using an elastic metal sheet. The cable-winding detent piece 103 is formed with a first end 1031 of which is formed in generally a hook shape for inwardly clasping the column 1023 and outwardly abutting to the clamping block 1024. A cantilever arm of linear extension 1033 extending from the first end 1031 toward the free end 1032 of the detent piece 103 of which is formed outward bended for engaging with the cable-releasing position slots 58′. The first end 1031 of the cable-winding detent piece 103 is inset in the gap formed between the column 1023 and the clamping block 1024 where the thickness of the cable-releasing detent piece 103 is smaller than the gap between the column 1023 and the clamping block 1024.

The cable-releasing detent piece 104 is formed all-in-one using an elastic metal sheet. The cable-releasing detent piece 104 is formed with a first end 1041 of which is formed in generally a hook shape for inwardly clasping the column 1025 and outwardly abutting to the clamping block 1024. A cantilever arm of linear extension 1043 extending from the first end 1041 toward the free end 1042 of the detent piece 104 of which is formed outward bended for engaging with the cable-releasing position slots 57′. The first end 1041 of the cable-releasing detent piece 104 is inset in the gap formed between the column 1025 and the clamping block 1024 where the thickness of the cable-releasing detent piece 104 is smaller than the gap between the column 1025 and the clamping block 1024.

After said components are assembled, the supporting seat 50′, the actuating part 102, and the gripping part 101, and the sleeve 55′ share a same axial center. The supporting seat 50′ is arranged securely at the body of the bicycle. The gripping part 101 may be rotated externally to make the cable-releasing detent suppressor 1013, the cable-winding detent suppressor 1014 to rotate synchronically. The rotating angle of the cable-releasing detent suppressor 1013 may cover the predefined range of the cable-releasing positioning slot 57′. The rotating angle of the cable-winding detent suppressor 1014 may cover the predefined range of the cable-winding positioning slot 58′. When the actuating piece 100 is rotated in counterclockwise direction, the actuating part 102 will not follow the gripping part 101 to rotate temporarily, because the cable-winding detent 103 and the cable-winding positioning slot 58′ are still meshed together. The cable-winding detent suppressor 1014 may stop pushing/lifting the cable-winding detent 103 so as to separate the same from the cable-winding positioning slot 58′. In the meantime, the cable-releasing detent suppressor 1013 at another side may therefore release the cable-releasing detent 104, such that the cable-releasing detent 104 and the cable-releasing positioning slot 57′ are meshed together. Next, the cable-winding detent suppressor 1014 is rotated to the left end of the hole 1021 and contacts the enforce block 1030 and starts to push the actuating part 102 along with the two detents 1013, 1014 fixed thereon. Vice versa, when the actuating piece 100 is rotated in clockwise direction, the actuating part 102 will not follow the gripping part 101 to rotate temporarily, because the cable-releasing detent 104 and the cable-releasing positioning slot 57′ are still meshed together. The cable-releasing detent suppressor 1013 may press down the cable-releasing detent 104 so as to separate the same from the cable-releasing positioning slot 57′. In the meantime, at another side, the cable-winding detent suppressor 1014 may therefore push and lift the cable-winding detent 104, such that the cable-releasing detent 104 and the cable-winding positioning slot 58′ are meshed together. Next, the cable-releasing detent suppressor 1013 rotates to the right end of the indentation 1022 and contacts the actuating part 102 and starts to push the actuating part 102 along with the two detents 1013, 1014 fixed thereon.

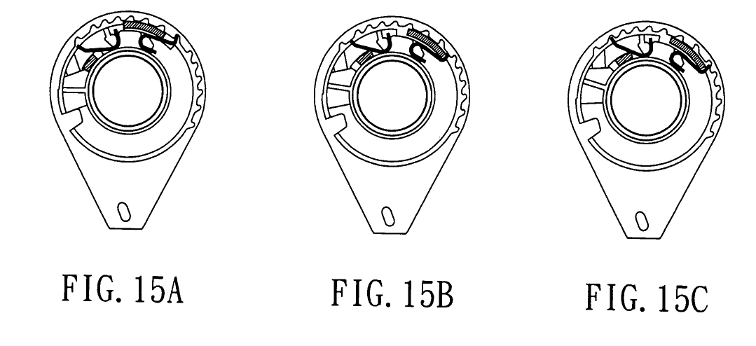

As seen in FIG. 15A to FIG. 15C, which are similar to the cable-winding actions shown in FIG. 6A to FIG. 6C, when each cable-winding action is proceeded, the cable-releasing detent 104 is always separated from the cable-releasing positioning slot 57′, so a smooth cable-winding action is guaranteed.

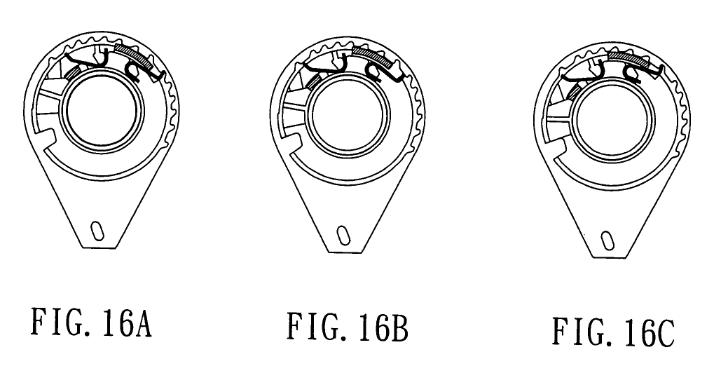

As seen in FIG. 16A to FIG. 16C, which are similar to the cable-releasing actions shown in FIG. 7A to FIG. 7C, when each cable-releasing action is proceeded, the cable-winding detent 103 is always separated from the cable-winding positioning slot 58′, so a smooth cable-releasing action is guaranteed.

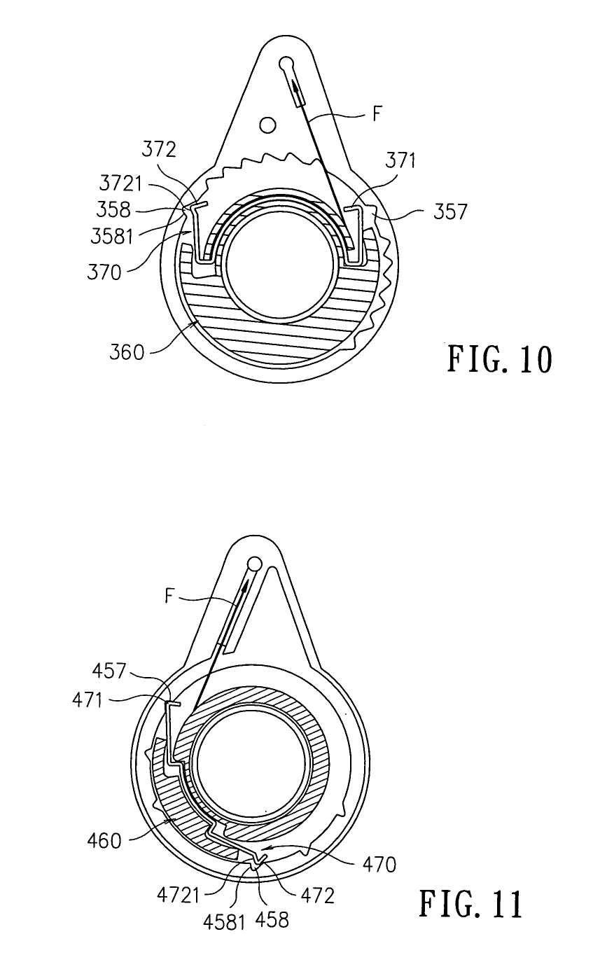

Please refer to FIG. 10. Since the actuating piece 360 is connected to the shifting cable so, no matter whether the actuating piece 360 is rotated in counterclockwise direction or in clockwise direction, the actuating piece 360 must be subjected to a pulling force F generated by the shifting cable. To resist the pulling force F for avoiding an unexpected cable-releasing, the cable-releasing contact surfaces 3721, 3581 between the cable-releasing detent 372 and the cable-releasing positioning slot 358 must be steeper. Similar structures that are arranged for the cable-releasing contact surfaces between the cable-winding detent 371 and the cable-winding positioning slot 357 may also have the same function and won't be described repetitiously herein. Please refer to FIG. 11. To resist the pulling force F applied upon the actuating piece 360 from the shifting cable for avoiding an unexpected cable-releasing, the cable-releasing contact surfaces 4721, 4581 between the cable-releasing detent 472 and the cable-releasing positioning slot 458 must be steeper. Similar structures that are arranged for the cable-releasing contact surfaces between the cable-winding detent 471 and the cable-winding positioning slot 457 may also have the same function. As for the slanting angles of these cable-releasing contact surfaces may be designed according to the meshing depths and sizes of the detent and the positioning slot, as long as it may reach the objective to resist the pulling force F.

In summarizing aforementioned description, the cable-winding action and the cable-releasing action according to the present invention are independent to each other, so the smoothness of shifting action may be guaranteed, and the wear of parts may be reduced effectively to prolong their life span. The cable-winding function and the cable-releasing function according to the present invention are operated independently, so the spacing distances of the cable-winding and cable-releasing positioning slots may be designed respectively according to the positions, of the positional points, needed by the cable-winding action and the cable-releasing action. Thereby, the guide pulley may accurately be meshed with the freewheel to successfully complete the cable-winding action and the cable-releasing action. Furthermore, the shifting function is enhanced, and the matching of relative parts (e.g., shifter, flywheel, and gearwheel) may be enhanced also, so its progressiveness, novelty, and industrial applicability are obviously possessed. However, the aforementioned description is only the preferable embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

What is claimed is:

1. A dual-detent shifting apparatus for pulling a shifting cable of a bicycle, comprising:
a supporting seat with an axial center arranged at the bicycle, having a plurality of cable-winding position slots continuously formed within a specific angular range of an inner periphery thereof and a plurality of cable-releasing position slots continuously formed within another specific angular range of the inner periphery thereof;
an actuating piece, connected to the shifting cable, being coaxially and pivotally connected to the supporting seat, and a cable-winding detent suppressor and a cable-releasing detent suppressor arranged around the circumference of an axial center thereof, such that accommodating spaces are formed between the periphery of the axial center of the actuating piece and the cable-winding detent suppressor, and between the periphery of the axial center of the actuating piece and the cable-releasing actuating block, wherein, the cable-winding detent suppressor synchro-rotates with the actuating piece and has a rotating angle covering the specific angular range of the cable-winding positioning slots, and the cable-releasing detent suppressor synchro-rotates with the actuating piece and has a rotating angle covering the specific angular range of the cable-releasing positioning slots; and
a detent piece having a cable-winding detent and a cable-releasing detent, wherein, the cable-winding detent is arranged in the accommodating space formed between the cable-winding detent suppressor and the axial center of the actuating piece, and the cable-releasing detent is arranged in the accommodating space formed between the cable-releasing detent suppressor and the axial center of the actuating piece;
wherein, when the actuating piece is rotated for a cable-releasing operation, the cable-winding detent suppressor will suppress the cable-winding detent for separating the same from the cable-winding positioning slot and the cable-releasing detent suppressor will releases the cable-releasing detent, such that the cable-releasing detent is inset into the cable-releasing positioning slot and the shifting cable will then be released so as to accomplish the cable-releasing operation; when the actuating piece is rotated for an cable-winding operation, the cable-releasing detent suppressor will suppress the cable-releasing detent for separating thereof from the cable-releasing positioning slot and the cable-winding detent suppressor will release the cable-winding detent, such that the cable-winding detent is inset into the cable-winding positioning slot and the shifting cable will be pulled to accomplish the cable-winding operation.

2. The dual-detent shifting apparatus according to claim 1, wherein the spacing distance between the cable-winding positioning slots is different from that of the cable-releasing positioning slots.

3. The dual-detent shifting apparatus according to claim 1, wherein the spacing distance between the cable-winding positioning slots is the same as that of the cable-releasing positioning slots.

4. The dual-detent shifting apparatus according to claim 1, wherein the detent piece is an all-in-one formed elastic metal sheet, and has an arcuate connecting part arranged between the cable-winding detent of the detent piece and the cable-releasing detent of the detent piece, that the arcuate connecting part is inset into an accommodating space formed between the inner wall of a flange arranged around the periphery of the axis center of the actuating piece and the outer periphery of the axial center.

5. The dual-detent shifting apparatus according to claim 1, wherein the cable-releasing contact surface of the positioning slot having steeper angle for providing the actuating piece with higher resistance to a pulling force of the shifting cable are arranged in one of the following position on the positioning slot: at the cable-releasing contact surfaces for contacting the cable-releasing detent and the cable-releasing positioning slot, at the cable-releasing contact surfaces for contacting the cable-winding detent and the cable-winding positioning slot.

6. A dual-detent shifting apparatus for pulling a shifting cable of a bicycle, comprising:
a supporting seat with an axial center arranged at the bicycle, having a plurality of cable-winding position slots continuously formed within a specific angular range of the inner periphery of the supporting seat and a plurality of cable-releasing position slots continuously formed within another specific angular range of the inner periphery of the supporting seat;
an actuating piece connected to the shifting cable, being coaxially and pivotally connected to the supporting seat, and a cable-winding detent suppressor and a cable-releasing detent suppressor arranged around the circumference of an axial center thereof, such that accommodating spaces are formed between the axial center of the actuating piece and the cable-winding detent suppressor, and between the axial center of the actuating piece and the cable-releasing actuating block, wherein, the cable-winding detent suppressor synchro-rotates with the actuating piece and has a rotating angle covering the specific angular range of the cable-winding positioning slots, and the cable-releasing detent suppressor synchro-rotates with the actuating piece and has a rotating angle covering the specific angular range of the cable-releasing positioning slots;
a cable-winding detent arranged in the accommodating space formed between the cable-winding detent suppressor and the axial center of the actuating piece;
a cable-releasing detent arranged in the accommodating space formed between the cable-releasing detent suppressor and the axial center of the actuating piece; and
a connecting part arranged between the cable-winding detent and the cable-releasing detent;
wherein, when the actuating piece is rotated for a cable-releasing operation, the cable-winding detent suppressor will suppress the cable-winding detent for separating thereof from the cable-winding positioning slot and the cable-releasing detent suppressor will releases the cable-releasing detent, such that the cable-releasing detent is inset into the cable-releasing positioning slot and the shifting cable will then be released so as to accomplish the cable-releasing operation; when the actuating piece is rotated for an cable-winding operation, the cable-releasing detent suppressor will suppress the cable-releasing detent for separating thereof from the cable-releasing positioning slot and the cable-winding detent suppressor will release the cable-winding detent, such that the cable-winding detent is inset into the cable-winding positioning slot and the shifting cable will be pulled to accomplish the cable-winding operation.

7. The dual-detent shifting apparatus according to claim 6, wherein the spacing distance between the cable-winding positioning slots is different from that of the cable-releasing positioning slots.

8. The dual-detent shifting apparatus according to claim 6, wherein the spacing distance between the cable-winding positioning slots is the same as that of the cable-releasing positioning slots.

9. The dual-detent shifting apparatus according to claim 6, wherein, the cable-winding detent is all-in-one formed of an elastic material, and has an elastic part formed as “ [symbol] ” shape, and a projecting part arranged at outside of the elastic part capable of being inset into the cable-winding positioning slot such that when the cable-winding detent suppressor presses down the elastic part formed as “ [symbol] ” shape and the projecting part, the projecting part will be separated from the cable-winding positioning slot, and when the cable-winding detent suppressor releases the elastic part formed as “ [symbol] ” shape and the projecting part, the projecting part will be meshed again with the cable-winding positioning slot; the cable-releasing detent is an all-in-one formed elastic material and has an elastic part formed as “ [symbol] ” shape, that a projecting part is arranged at outside of the elastic part and is inset into the cable-releasing positioning slot such that when the cable-releasing detent suppressor presses down the elastic part formed as “ [symbol] ” shape and the projecting part, the projecting part will be separated from the cable-releasing positioning slot, and when the cable-releasing detent suppressor releases the elastic part formed as “ [symbol] ” shape and the projecting part, the projecting part will be meshed again with the cable-releasing positioning slot.

10. The dual-detent shifting apparatus according to claim 6, wherein cable-releasing contact surface of the positioning slot having steeper angle for providing the actuating piece with higher resistance to a pulling force of the shifting cable are arranged in one of the following position on the positioning slot: at the cable-releasing contact surfaces for contacting the cable-releasing detent and the cable-releasing positioning slot, at the cable-releasing contact surfaces for contacting the cable-winding detent and the cable-winding positioning slot.

11. A dual-detent shifting apparatus for pulling a shifting cable of a bicycle, comprising:
a supporting seat with an axial center arranged at the bicycle, having a plurality of cable-winding position slots continuously formed within a specific angular range of the inner periphery of the supporting seat and a plurality of cable-releasing position slots continuously formed within another specific angular range of the inner periphery of the supporting seat;
an actuating piece, being coaxially and pivotally connected to the supporting seat, further comprising:
a gripping part further comprising:
a hollow grip; and
an enlarged portion, having an arc-shaped cable-winding detent suppressor, an arc-shaped cable-releasing detent suppressor, two arc-shaped positioning block being arranged on a circular plate thereof, and the circular plate being coaxially connected to the grip;
an actuating part, being a hollow circular plate with an arc-shaped indentation and a arc-shaped hole arranged respectively at the positions thereof corresponding to the cable-releasing detent suppressor and the cable-winding detent suppressor, wherein the indentation is used for accommodating the cable-releasing detent suppressor, and the hole is used for accommodating the cable-winding detent suppressor, and the arc widths of both the hole and the indentation are larger than those of the two suppressors, in addition, a side of the circular plate facing toward the supporting seat is formed thereon with two columns, a wall, a clamping block and a enforce block, and the two columns respectively cooperating with the clamping block is capable of clamping and fastening the cable-releasing detent and the cable winding detent, and the cable-winding detent suppressor synchro-rotates with the actuating piece and has a rotating angle covering the specific angular range of the cable-winding positioning slots, and the cable-releasing detent suppressor synchro-rotates with the actuating piece and has a rotating angle covering the specific angular range of the cable-releasing positioning slots;
a cable-winding detent piece, being formed with a first end in a hook shape for inwardly clasping the column disposed at the right of the hole and outwardly abutting to the clamping block, and a cantilever arm of linear extension extending from the first end toward a free end thereof which is formed outward bended for engaging with the cable-releasing position slots, wherein the first is inset in the gap formed between the column at the right of the hole and the clamping block;
a cable-releasing detent piece, being formed with a first end in a hook shape for inwardly clasping the column disposed corresponding to the indentation and outwardly abutting to the clamping block, and a cantilever arm of linear extension extending from the first end toward a free end thereof which is formed outward bended for engaging with the cable-winding position slots, wherein the first end of the cable-releasing detent piece is inset in the gap formed between the column disposed corresponding to the indentation and the clamping block.
wherein, when the actuating piece is rotated for a cable-winding operation, the cable-releasing detent suppressor will suppress the cable-releasing detent for separating thereof from the cable-releasing positioning slot and the cable-winding detent suppressor will engaging and lifting the cable-winding detent, such that the cable-winding detent is inset into the cable-winding positioning slot and the shifting cable will then be pulled so as to accomplish the cable-winding operation; when the actuating piece is rotated for an cable-releasing operation, the cable-winding detent suppressor will release the cable-winding detent for separating thereof from the cable-winding positioning slot and the cable-releasing detent suppressor will release the cable-releasing detent, such that the cable-releasing detent is inset into the cable-winding positioning slot and the shifting cable will be releasing to accomplish the cable-releasing operation.

12. The dual-detent shifting apparatus according to claim 11, wherein the spacing distance between the cable-winding positioning slots is different from that of the cable-releasing positioning slots.

13. The dual-detent shifting apparatus according to claim 11, wherein the spacing distance between the cable-winding positioning slots is the same as that of the cable-releasing positioning slots.

14. The dual-detent shifting apparatus according to claim 11, wherein the cable-releasing detent piece is an all-in-one formed elastic metal sheet.

15. The dual-detent shifting apparatus according to claim 11, wherein the cable-winding detent piece is an all-in-one formed elastic metal sheet.

16. The dual-detent shifting apparatus according to claim 11, wherein the cable-releasing contact surface of the positioning slot having steeper angle for providing the actuating piece with higher resistance to a pulling force of the shifting cable are arranged in one of the following position on the positioning slot: at the cable-releasing contact surfaces for contacting the cable-releasing detent and the cable-releasing positioning slot, at the cable-releasing contact surfaces for contacting the cable-winding detent and the cable-winding positioning slot.
